(19) United States
(12) Patent Application Publication
(10) Pub. No.: US 2026/0060309 A1
(43) Pub. Date: Mar. 5, 2026

(54) AEROSOL GENERATING DEVICE AND PUFF DETECTION METHOD THEREFOR

(71) Applicant: SMOORE INTERNATIONAL HOLDINGS LIMITED, George Town (KY)

(72) Inventors: Pengfei HUANG, Shenzhen (CN); Xiangzhong LI, Shenzhen (CN)

(21) Appl. No.: 19/384,262

(22) Filed: Nov. 10, 2025

Related U.S. Application Data
(63) Continuation of application No. PCT/CN2024/091474, filed on May 7, 2024.

(30) Foreign Application Priority Data
May 9, 2023 (CN) 202310519862.4

(51) Int. Cl. A24F 40/46; A24F 40/53; A24F 40/57

(52) U.S. Cl. CPC A24F 40/46; A24F 40/53; A24F 40/57

(57) ABSTRACT

An aerosol generating device includes: a heating structure; a temperature measurement unit; and a control unit. The heating structure has a heating element and a housing. The heating element is at least partially spaced apart from the housing, the heating being powered for heating and generating infrared light, the infrared light passing through the housing so as to heat an aerosol-forming substrate. The temperature measurement unit is arranged on the heating structure or is spaced apart from the heating structure, and measures a temperature of the heating structure. The control unit monitors the temperature of the heating structure and detect a puffing action of a user according to a change in the temperature of the heating structure.

### CROSS-REFERENCE TO PRIOR APPLICATION

This application is a continuation of International Patent Application No. PCT/CN2024/091474, filed on May 7, 2024, which claims priority to Chinese Patent Application No. 202310519862.4, filed on May 9, 2023. The entire disclosure of both applications is hereby incorporated by reference herein.

### FIELD

The present invention relates to the field of heat-not-burn, and more specifically, to an aerosol generating device and a puff detection method therefor.

### BACKGROUND

In addition to detection by an airflow sensor, a puffing action on a heat-not-burn aerosol generating device may be detected by using a temperature drop difference of a heating element currently.

An airway structure is complicated when the puffing action is detected by the airflow sensor. In the solution that the puffing action is detected by the heating element, an effect of cooling the heating element is not obvious during puffing because the heating element generates heat. As a result, the sensitivity of detecting the puffing action is not accurate.

### SUMMARY

In an embodiment, the present invention provides an aerosol generating device, comprising: a heating structure; a temperature measurement unit; and a control unit, wherein the heating structure comprises a heating element and a housing, wherein the heating element is at least partially spaced apart from the housing, the heating element is configured to be powered for heating and generating infrared light, the infrared light passing through the housing so as to heat an aerosol-forming substrate, wherein the temperature measurement unit is arranged on the heating structure or is spaced apart from the heating structure, and is configured to measure a temperature of the heating structure, and wherein the control unit is configured to monitor the temperature of the heating structure and detect a puffing action of a user according to a change in the temperature of the heating structure.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an aerosol generating device according to Embodiment 1 of the present invention;

FIG. 2 is a schematic structural diagram of a heating structure of the aerosol generating device shown in FIG. 1;

FIG. 3 is a sectional view of the heating structure shown in FIG. 2;

FIG. 4 is a schematic structural exploded view of the heating structure shown in FIG. 2;

FIG. 5 is a block diagram of a temperature measurement principle of an aerosol generating device according to the present invention;

FIG. 6 is a block diagram of a principle of temperature measurement by using a thermocouple according to the present invention;

FIG. 7 is a circuit diagram of the embodiment shown in FIG. 5;

FIG. 8 is a block diagram of a principle of temperature measurement by using a resistance temperature measuring film or an NTC according to the present invention;

FIG. 9 is a circuit diagram of the embodiment shown in FIG. 8;

FIG. 10 is a schematic diagram of a temperature change curve during puffing;

FIG. 11 is a schematic structural diagram of a heating structure of an aerosol generating device according to Embodiment 2 of the present invention;

FIG. 12 is a schematic structural diagram of the heating structure shown in FIG. 11 from another angle;

FIG. 13 is a sectional view of the heating structure shown in FIG. 11; and

FIG. 14 is a schematic structural exploded view of the heating structure shown in FIG. 11.

### DETAILED DESCRIPTION

In an embodiment, the present invention provides an improved aerosol generating device and further provide a puff detection method for the improved aerosol generating device.

In an embodiment, the present invention provides an aerosol generating device, including a heating structure, a temperature measurement unit, and a control unit, where the heating structure includes a heating element and a housing; the heating element is at least partially spaced apart from the housing, the heating element is electrified for heating and generates infrared light, and the infrared light passes through the housing to heat an aerosol-forming substrate;
the temperature measurement unit is arranged on the heating structure or is spaced apart from the heating structure, and is configured to measure the temperature of the heating structure; and
the control unit monitors the temperature of the heating structure and detects a puffing action of a user according to a change in the temperature of the heating structure.

In some embodiments, the temperature measurement unit is arranged on the inner wall or the outer wall of the housing.

In some embodiments, the temperature measurement unit is spaced apart from the heating element or is closely attached to the heating element.

In some embodiments, the temperature measurement unit is spaced apart from the heating element or is closely attached to the heating element, the housing has an opening, and the temperature measurement unit is arranged close to the opening.

In some embodiments, the heating element is located inside the housing, and the housing is at least partially configured to be inserted into the aerosol-forming substrate.

In some embodiments, the heating element is arranged on the periphery of the housing in a spaced-apart manner, and the housing is hollow and forms a second accommodating cavity for accommodating the aerosol-forming substrate.

In some embodiments, the housing includes a first tube and a second tube sleeved on the periphery of the first tube;
a gap is provided between the first tube and the second tube, and the gap forms a first accommodating cavity for accommodating the heating element; and
the heating element is arranged on the periphery of the first tube and is spaced apart from the outer wall of the first tube, and a second accommodating cavity for heating the aerosol-forming substrate is formed inside the first tube.

In some embodiments, the control unit includes a temperature measurement module; and
the temperature measurement module is connected to the temperature measurement unit, and is configured to monitor the temperature of the temperature measurement unit in real time to obtain the temperature of the heating structure.

In some embodiments, the temperature measurement unit includes a first temperature sensor or a second temperature sensor;
the first temperature sensor includes a thermocouple; and
the second temperature sensor includes a resistance temperature measuring film or a thermistor.

In some embodiments, the control unit includes a heating module and a controller;
the heating module is connected to the heating element, and the heating module adjusts, according to control by the controller, electric energy provided to the heating element; and
the controller controls output power of the heating module to control the temperature of the heating element, monitors the temperature of the heating structure, and detects the puffing action of the user according to the change in the temperature of the heating structure.

In some embodiments, the control unit detects the puffing action of the user according to a change in the temperature of the heating structure within a preset time range.

In some embodiments, the control unit detects the puffing action of the user according to whether the change in the temperature of the heating structure exceeds a threshold within the preset time range.

In some embodiments, the control unit detects the puffing action of the user according to whether a drop value of the temperature of the heating structure is greater than a drop threshold within the preset time range, or
the control unit detects the puffing action of the user according to whether a drop slope of the temperature of the heating structure is greater than a preset slope within the preset time range.

In some embodiments, the temperature measurement unit includes a first temperature measuring element and a second temperature measuring element;
the first temperature measuring element is arranged on the heating structure or is spaced apart from the heating structure, and the first temperature measuring element is arranged close to an opening of the housing and is configured to measure the temperature of the heating structure to obtain a first real-time temperature;
the second temperature measuring element is arranged on the heating structure or is spaced apart from the heating structure, and the second temperature measuring element is arranged away from the opening and is configured to measure the temperature of the heating structure to obtain a second real-time temperature; and
the control unit determines whether the user is in an exhaling state or an inhaling state according to the first real-time temperature and the second real-time temperature.

In some embodiments, the control unit controls an indicating module to output a mode misuse warning signal when determining that the user is in the exhaling state, or
the control unit reduces heating power when determining that the user is in the exhaling state.

The present invention further provides a puff detection method for an aerosol generating device, where the aerosol generating device includes a heating structure, a temperature measurement unit, and a control unit, where the heating structure includes a heating element and a housing; the heating element is at least partially spaced apart from the tube wall of the housing, the heating element is electrified for heating and generates infrared light, and the infrared light passes through the housing to heat an aerosol-forming substrate; and the puff detection method includes the following steps:
measuring the temperature of the heating structure by the temperature measurement unit arranged on the heating structure or spaced apart from the heating structure; and
monitoring the temperature of the heating structure by the control unit, and detecting a puffing action of a user according to a change in the temperature of the heating structure.

In some embodiments, the temperature measurement unit includes a first temperature measuring element and a second temperature measuring element; the first temperature measuring element is arranged on the heating structure or is spaced apart from the heating structure, and the first temperature measuring element is arranged close to an opening of the housing; the second temperature measuring element is arranged on the heating structure or is spaced apart from the heating structure, and the second temperature measuring element is arranged away from the opening; and
the puff detection method further includes the following steps:
measuring the temperature of the heating structure by the first temperature measuring element to obtain a first real-time temperature;
measuring the temperature of the heating structure by the second temperature measuring element to obtain a second real-time temperature; and
determining, by the control unit, whether the user is in an exhaling state or an inhaling state according to the first real-time temperature and the second real-time temperature.

In some embodiments, the puff detection method further includes:
controlling, by the control unit, an indicating module to output a mode misuse warning signal when determining that the user is in the exhaling state, or
reducing, by the control unit, heating power when determining that the user is in the exhaling state.

The aerosol generating device and the puff detection method therefor according to the present invention have the following beneficial effects: According to the aerosol generating device, the temperature of the heating structure is measured by the additionally-arranged temperature measurement unit. When the user performs a puffing action, because an airflow passes through the temperature measurement unit to make the temperature of the temperature measurement unit drop rapidly, the control unit can determine whether a puffing action occurs according to the change in the temperature of the temperature measurement unit. Moreover, since the detection and determining are performed by using the change in the temperature of the temperature measurement unit during puffing, the problem of low detection sensitivity caused by a small change in a resistance value of the heating structure can be solved. In addition, there is no need to arrange a complicated airway structure by measuring the change in the temperature through the temperature measurement unit.

The technical solutions in the embodiments of the present invention are clearly and completely described below with reference to the accompanying drawings in the embodiments of the present invention. Clearly, the described embodiments are merely some rather than all of the embodiments of the present invention. All other embodiments obtained by a person of ordinary skill in the art based on the embodiments of the present invention without creative efforts shall fall within the protection scope of the present invention.

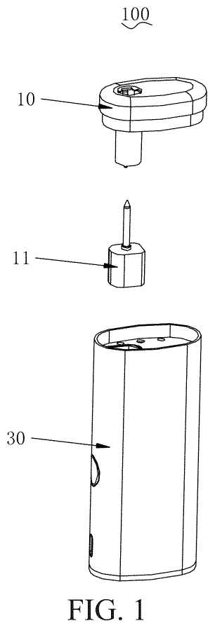

FIG. 1 shows an aerosol generating device 100 according to Embodiment 1 of the present invention. In this embodiment, the aerosol generating device 100 can heat an aerosol-forming substrate in a heat-not-burn manner. In some embodiments, the aerosol-forming substrate is arranged on the aerosol generating device 100 in an insertable and removable manner, and the aerosol-forming substrate may be cylindrical. Specifically, the aerosol-forming substrate may be a strip-shaped, sheet-like, granular or integrally-formed solid state material made of leaves and/or stems of plants (such as tobacco), and an aroma component may be further added to the solid state material.

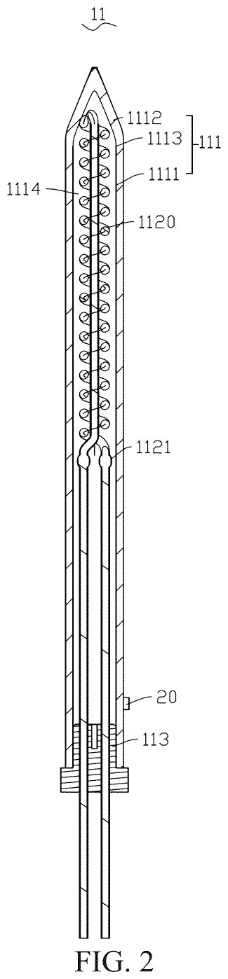

Further, as shown in FIG. 1 and FIG. 2, the aerosol generating device 100 includes an upper cover assembly 10, a heating structure 11, a temperature measurement unit 20, and a control unit 30. The heating structure 11 can be partially inserted into the aerosol-forming substrate. Specifically, the heating structure 11 can be at least partially inserted into a substrate segment of the aerosol-forming substrate, and generate infrared light when in an energized state, to heat the substrate segment of the aerosol-forming substrate, so that the substrate segment generates an aerosol after being heated.

As shown in FIG. 2 to FIG. 4, in this embodiment, the heating structure 11 is a central heating structure. The heating structure 11 includes a heating element 112, a housing 111, and a base 113. The heating element 112 is at least partially spaced apart from the housing 111. The heating element 112 is located in the housing 111, and the housing 111 is at least partially configured to be inserted into the aerosol-forming substrate. The heating element 112 is electrified for heating and generates infrared light. For example, a gap 1114 is provided between the housing 111 and the heating element 112, and the gap 1114 may be filled with air. Certainly, it may be understood that in some other embodiments, the gap 1114 may alternatively be filled with a reducing gas or an inert gas. The housing 111 accommodates at least part of the heating element 112, and allows the infrared light generated by the heating element 112 to pass through to heat the aerosol-forming substrate. Specifically, the housing 111 allows the infrared light generated by the heating element 112 to pass through, such that at least part of the infrared light generated by the heating element 112 is absorbed by the aerosol to heat the aerosol-forming substrate. The substrate 113 is arranged at an opening 1110 of the housing 111.

In this embodiment, the housing 111 may be made of glass. For example, the housing 111 may be made of quartz glass. Alternatively, in some other embodiments, the housing 111 is not limited to being made of quartz glass, but may be made of another window material allowing infrared light to pass through, such as infrared transparent glass, transparent ceramics, or diamond.

In this embodiment, the housing 111 is a hollow tube, namely a tube made of transparent quartz glass. The housing 111 is of a longitudinal structure with two end portions distributed in an axial direction. The longitudinal structure refers to that a dimension of the housing 111 in one direction (for example, a length direction) is greater than that in the other direction (for example, a thickness direction). Specifically, the housing 111 includes a tubular body 1111 with a circular cross section, and a pointed structure 1112 arranged at an end of the tubular body 1111. Certainly, it may be understood that in some other embodiments, the cross section of the tubular body 1111 is not limited to being circular. The tubular body 1111 is of a hollow structure with an end provided with an opening 1110. The pointed structure 1112 is arranged at an end of the tubular body 1111 away from the opening 1110, and at least part of the heating structure 11 can be easily inserted into the aerosol-forming substrate by arranging the pointed structure 1112. In this embodiment, a first accommodating cavity 1113 is formed inside the housing 111, and the first accommodating cavity 1113 is a columnar cavity. In this implementation, the tubular body 1111 is a cylinder, and the pointed structure 1112 is a cone. In another implementation, the housing 111 may alternatively be in another form, such as a triangular prism, a cuboid, or another shape. In some other embodiments, the heating element 112 may alternatively be arranged on the periphery of the housing 111 in a spaced-apart manner, and a second accommodating cavity for accommodating the aerosol-forming substrate may be formed inside the housing 111.

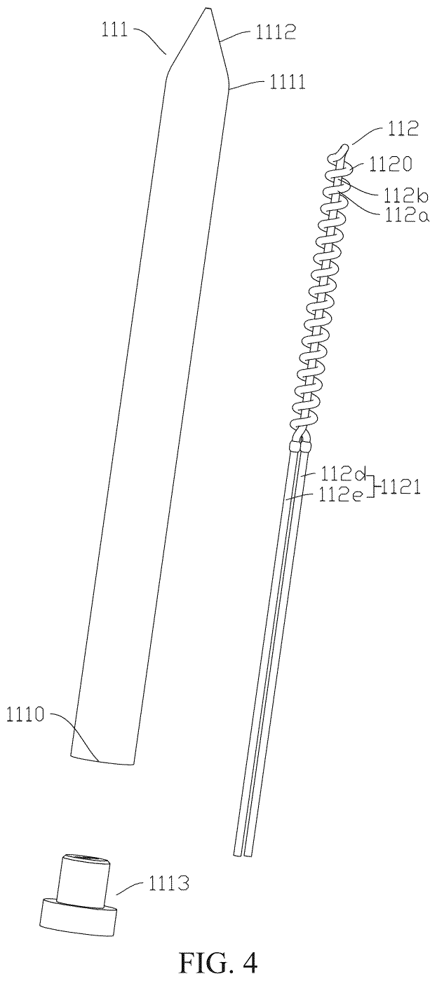

As shown in FIG. 4, in this embodiment, one heating element 112 may be provided and may be longitudinally arranged, with a first free end 112d and a second free end 112e. In this implementation, the heating element 112 is in the shape of a strip (solid round wire) with a circular cross section. The heating element 112 is at least partially bent to form a columnar heating part 1120 as a whole. Specifically, the heating element can be bent to form a spiral columnar heating part 1120. It may be understood that in some other embodiments, the heating element 112 is not limited to being in the shape of a strip, but may be in the shape of an elongated sheet or a mesh. The heating part 1120 is not limited to being in the shape of a column, but may alternatively be in the shape of a sheet, a mesh, or a strip. In some embodiments, the heating element 112 may be wound to form a heating part 1120 in the shape of a single spiral, a double spiral, an M, an N, or another shape. Certainly, it may be understood that in some other embodiments, the number of the heating elements 112 is not limited to one, but may be two or more than two. It should be noted that in some other embodiments, the heating element 112 may alternatively be a metal sheet or a metal needle.

In this embodiment, the heating part 1120 includes a first heating part 112a and a second heating part 112b; and an end of the first heating part 112a is connected to an end of the second heating part 112b. In this embodiment, the first heating part 112a and the second heating part 112b are of an integrally formed structure and can be formed by bending one heating element 112. It may be understood that in some other embodiments, the first heating part 112a and the second heating part 112b may alternatively be of a split structure, and the first heating part 112a and the second heating part 112b may respectively be two heating elements 112 connected together through welding, riveting, or the like. It may be understood that in some other embodiments, the second heating part 112b may alternatively be omitted and may be replaced with a non-heating conductive rod.

In this embodiment, a conductive part 1121 is arranged at an end of the heating part 1120. The conductive part 1121 is connected to the heating part 1120, can be led out from an end portion of the housing 111, and penetrates through the base 113 to be electrically connected to a power supply component in the control unit 30. In this embodiment, two conductive parts 1121 may be provided, and the two conductive parts 1121 may be spaced apart, are separately connected to the heating part 1120, and penetrate out of the housing 111 from the same end of the housing 111. In this embodiment, the conductive parts 1121 may be fixed to the heating part 1120 by welding. Certainly, it may be understood that in some other embodiments, the heating part 1120 may be integrally formed with the conductive part 1121, and the first free end 112d and the second free end 112e of the heating element 112 can form two conductive parts 1121 respectively. That is, the first free end 112d of the first heating part 112a forms one of the conductive parts 1121; and the second free end 112e of the second heating part 112b forms the other conductive part 1121. In some other embodiments, the conductive part 1121 may be a lead with resistance less than that of the heating part, for example, a lead made of a silver or aluminum material, and may be welded to the heating part 1120. Certainly, it may be understood that in some other embodiments, the conductive part 1121 is not limited to being a lead, but may be of another conductive structure.

In this embodiment, different from a heating element of an existing e-cigarette, the heating element 112 may have a maximum operating temperature in the range from 500° C. to 1300° C. That is, during the entire operating period of the heating element 112, the maximum operating temperature of the heating element may be any temperature between 500° C. and 1300° C., and can be specifically determined according to a temperature control requirement. However, in the prior art, the maximum operating temperature of the heating element is generally only within 400° C. Specifically, in this embodiment, the operating temperature of the heating element 112 includes a first operating temperature range and a second operating temperature range. The first operating temperature range may be an operating temperature range during preheating, with a maximum temperature of 700° C. to 1300° C. At this temperature, the aerosol-forming substrate can be preheated by infrared heat in a very short time, thereby ensuring a smoke amount and taste of about the first three mouthfuls of aerosol during puffing by the user. Specifically, in the energized state, the heating element 112 can rapidly raise the temperature from room temperature to about 1000° C. in 1-3 s, and the second operating temperature range may be an operating temperature range when the aerosol is normally generated and puffed on by the user after the aerosol-forming substrate is preheated, with a maximum temperature of 500° C. to 800° C. Certainly, it may be understood that in some other embodiments, ranges of the operating temperature of the heating element 112 are not limited to two ranges, for example, a cooling stage after the second operating temperature range is further included. Because of the gap 1114, the surface temperature of the housing 111 can be controlled at 350° C. or below, and the heating temperature of the entire aerosol-forming substrate is controlled at 300° C. to 350° C., so that the aerosol-forming substrate can be accurately heated mainly in an infrared band of 2 μm to 5 μm.

In some embodiments, the heating part 1120 includes a heating substrate and an infrared radiation layer coated outside the heating substrate. The heating substrate includes a metal substrate with high-temperature oxidation resistance, such as a metal wire, and the heating substrate may be a metal material with good high-temperature oxidation resistance, high stability, non-susceptibility to deformation, and the like, such as a nickel-chromium alloy substrate (such as a nickel-chromium alloy wire) or an iron-chromium-aluminum alloy substrate (such as an iron-chromium-aluminum alloy wire). In some embodiments, a diameter of the metal wire may range from 0.15 mm to 0.8 mm. The metal wire may be bent or wound into various shapes, such as a spiral, a mesh, an M shape, or an N shape, and the entire bent or wound heating element 112 is in the shape of a column, a spiral segment, a mesh, or another three-dimensional or planar shape with a bend.

In some embodiments, the heating element 112 further includes an anti-oxidation layer, and the anti-oxidation layer is formed between the heating substrate and the infrared radiation layer. Specifically, the anti-oxidation layer may be an oxide film, and the heating substrate undergoes high-temperature heat treatment to form a dense oxide film on the surface of the heating substrate. The oxide film forms the anti-oxidation layer. Certainly, it may be understood that in some other embodiments, the anti-oxidation layer is not limited to including the oxide film forming the anti-oxidation layer. In some other embodiments, the anti-oxidation layer may be an anti-oxidation coating applied to the outer surface of the heating substrate. A thickness of the anti-oxidation layer may be selected as 1 μm to 150 μm.

In some embodiments, the infrared radiation layer may be an infrared layer. The infrared layer may be formed on a side of the anti-oxidation layer away from the heating substrate by an infrared layer-forming substrate under high-temperature heat treatment. Specifically, the infrared layer-forming substrate may be silicon carbide, spinel or a composite substrate thereof. Certainly, it may be understood that in some other embodiments, the infrared radiation layer is not limited to the infrared layer. In some embodiments, the infrared radiation layer may be a composite infrared layer. Specifically, the infrared layer can be formed on a side of the anti-oxidation layer away from the heating substrate by dip coating, spray coating, brush coating, or the like. The thickness of the infrared radiation layer may range from 10 μm to 300 μm.

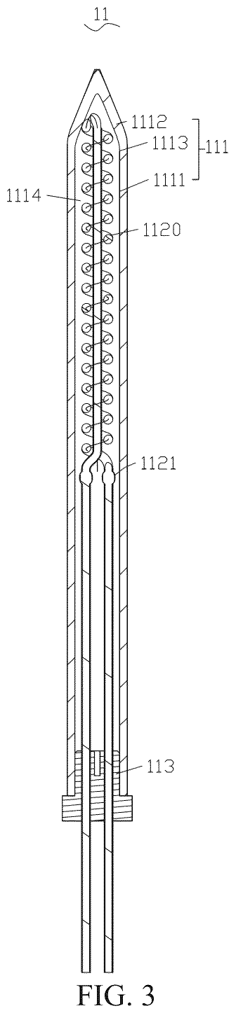

As shown in FIG. 2 and FIG. 3, in this embodiment, the temperature measurement unit 20 is arranged on the heating structure 11 or is spaced apart from the heating structure 11. The temperature measurement unit 20 may be spaced apart from the heating element 112 or may be closely attached to the heating element 112. Further, in this embodiment, as shown in FIG. 4, the temperature measurement unit 20 may be arranged close to the opening 1110 of the housing 111. The “close to” herein refers to that with a midpoint of the length of the housing 111 as a reference, a shorter distance from an end at the opening 1110 indicates being close, and a longer distance from the end at the opening 1110 indicates being far. Specifically, the temperature measurement unit 20 may be arranged on the inner wall or the outer wall of the housing 111. The temperature of the heating structure 11 can be measured by arranging the temperature measurement unit 20. The operating temperature of the light wave infrared heating element 112 is 500° C. to 1300° C., and the gap 1114 is provided between the heating element 112 and the housing 111. Because of the gap 1114, the surface temperature of the housing 111 can be controlled at 350° C. or below. Therefore, when the temperature measurement unit 20 is arranged on the inner wall or the outer wall of the housing 111, the sensitivity of temperature measurement is higher.

In this embodiment, the temperature measurement unit 20 includes a first temperature sensor or a second temperature sensor.

The first temperature sensor includes a thermocouple; and the second temperature sensor includes a resistance temperature measuring film or a thermistor formed on the housing by screen printing, physical vapor deposition (PVD), or the like. Specifically, in this embodiment, the temperature measurement unit 20 may be a thermocouple, a temperature measuring film, a negative temperature coefficient (NTC) thermistor, a positive temperature coefficient (PTC) thermistor, or the like. Certainly, it may be understood that in some other embodiments, the temperature measurement unit 20 is not limited to the temperature sensor mentioned above, and another sensor or temperature measuring element may alternatively be used for measurement, as long as the temperature of the heating element can be accurately measured.

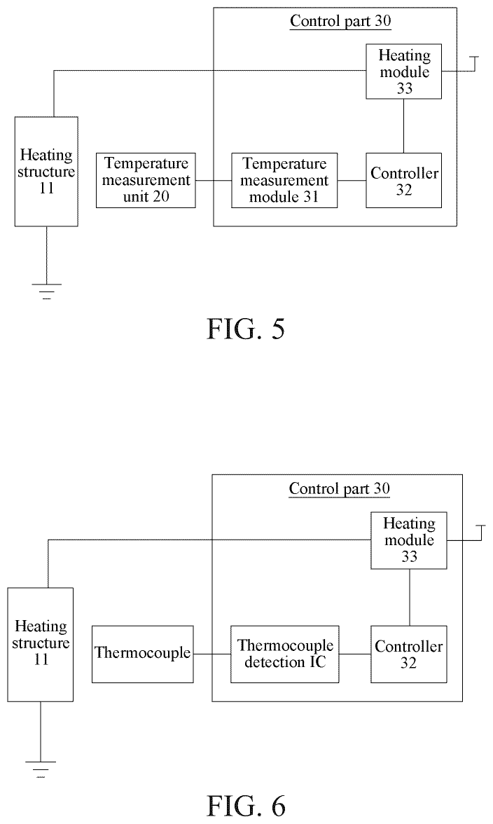

As shown in FIG. 5, in this embodiment, the control unit 30 is connected to the temperature measurement unit 20 and is configured to receive a signal outputted by the temperature measurement unit 20, to monitor the temperature of the heating structure 11 and detect a puffing action of a user according to a change in the temperature of the heating structure 11.

In this embodiment, the control unit 30 detects the puffing action of the user according to a change in the temperature of the heating structure 11 within a preset time range. Specifically, the control unit 30 detects the puffing action of the user according to whether the change in the temperature of the heating structure 11 exceeds a threshold within the preset time range. In this embodiment, the control unit 30 detects the puffing action of the user according to whether a drop value of the temperature of the heating structure 11 is greater than a drop threshold within the preset time range, or the control unit 30 detects the puffing action of the user according to whether a drop slope of the temperature of the heating structure 11 is greater than a preset slope within the preset time range.

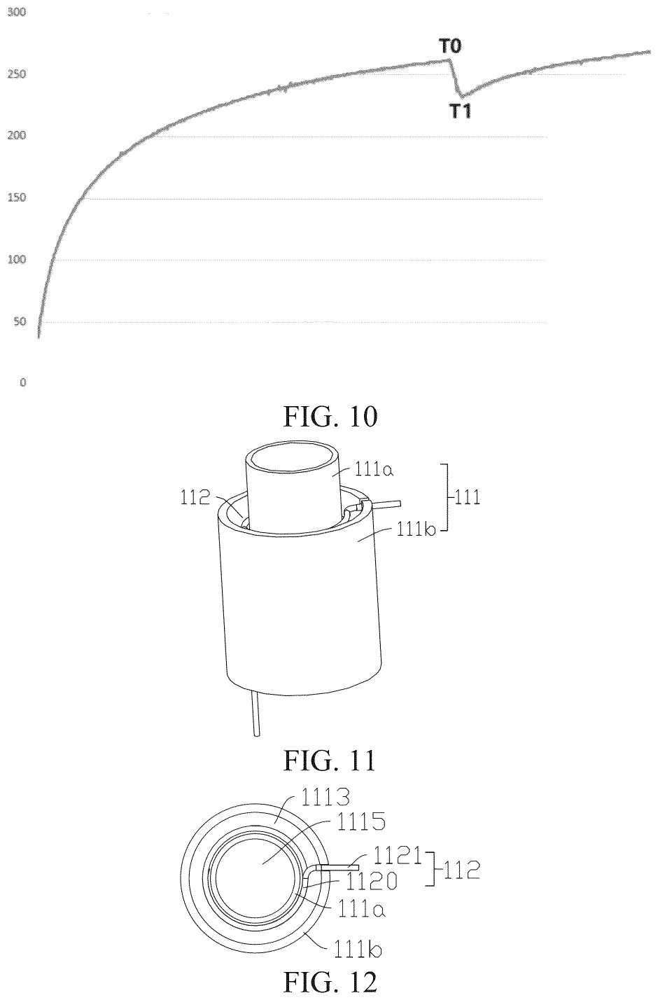

In this embodiment, FIG. 10 is a schematic diagram of a temperature change curve during puffing, where a horizontal axis represents time, a vertical axis represents temperature, and the unit of the temperature is degree centigrade. The temperature of the temperature measurement unit 20 is T0 at a moment before the user puffs. When the user is puffing, the temperature of the temperature measurement unit 20 suddenly drops because an airflow formed by puffing passes through the heating structure (that is, the airflow flows through the temperature measurement unit 20). Assuming that the temperature of the temperature measurement unit 20 drops to T1 at a moment before the puffing action is completed, the temperature of the temperature measurement unit 20 gradually rises to the original temperature TO after the puffing action is completed. Therefore, the controller 32 can determine, by calculating temperature difference ΔT=T0−T1 between T0 and T1, whether a puffing action occurs according to ΔT. For example, if ΔT is greater than the drop threshold (set as T Threshold) within the preset time range, it is determined that a puffing action occurs. Alternatively, if ΔT/t is greater than the preset slope (set as k0) within the preset time range, it is determined that a puffing action occurs, where t is a preset time.

Further, in this embodiment, if the controller 32 detects that the temperature of the temperature measurement unit 20 starts to rise from T1, it can be determined that this puffing action is completed, and detection of the next puffing can be performed.

Further, as shown in FIG. 5, in this embodiment, the control unit 30 includes a temperature measurement module 31; and the temperature measurement module 31 is connected to the temperature measurement unit 20, and is configured to monitor the temperature of the temperature measurement unit 20 in real time to obtain the temperature of the heating structure 11. In this embodiment, as shown in FIG. 6, when a thermocouple is adopted for the temperature measurement unit 20, a thermocouple detection IC may be adopted for the temperature measurement module 31. Specifically, the thermocouple detection IC is connected to the temperature measurement unit 20, and is configured to detect a signal generated by the temperature measurement unit 20 and output a corresponding detection signal.

Further, as shown in FIG. 6, the control unit 30 includes a heating module 33 and a controller 32. The heating module 33 is connected to the heating element 112, and the heating module 33 adjusts, according to control by the controller 32, electric energy provided to the heating element 112. The controller 32 controls output power of the heating module 33 to control the temperature of the heating element 112, monitors the temperature of the heating structure 11, and detects the puffing action of the user according to the change in the temperature of the heating structure 11. Specifically, when the aerosol generating device 100 is operating, the controller 32 controls the heating module 33 to drive the heating element 112 for heating, and the controller 32 measures the temperature of the temperature measurement unit 20 through the thermocouple detection IC. After heating begins, the temperature of the temperature measurement unit 20 rises rapidly and gradually reaches a balance, and changes with the rise/fall of the temperature curve at a corresponding time. Because the temperature measurement unit 20 is arranged close to the opening 1110 of the housing 111 of the heating element 112, and the temperature measurement unit 20 is arranged at a position where an airflow passes on the heating element 112, the temperature of the temperature measurement unit 20 is in a relatively stable state when the user does not puff. When the user puffs, the temperature of the temperature measurement unit 20 drops rapidly because an airflow passes through the temperature measurement unit 20. Therefore, the controller 32 can measure the temperature of the temperature measurement unit 20 in real time and determines whether a puffing action occurs by using a change in the temperature of the temperature measurement unit. In this embodiment, the temperature of the heating element 112 is detected by the temperature measurement unit 20 outside the heating element 112. Therefore, the temperature measurement unit is not affected by a change in a resistance value of the heating element 112, and the detection sensitivity is high. In addition, there is no need to arrange a complicated airway structure. This not only simplifies the structure of the aerosol generating device 100, but also reduces product costs.

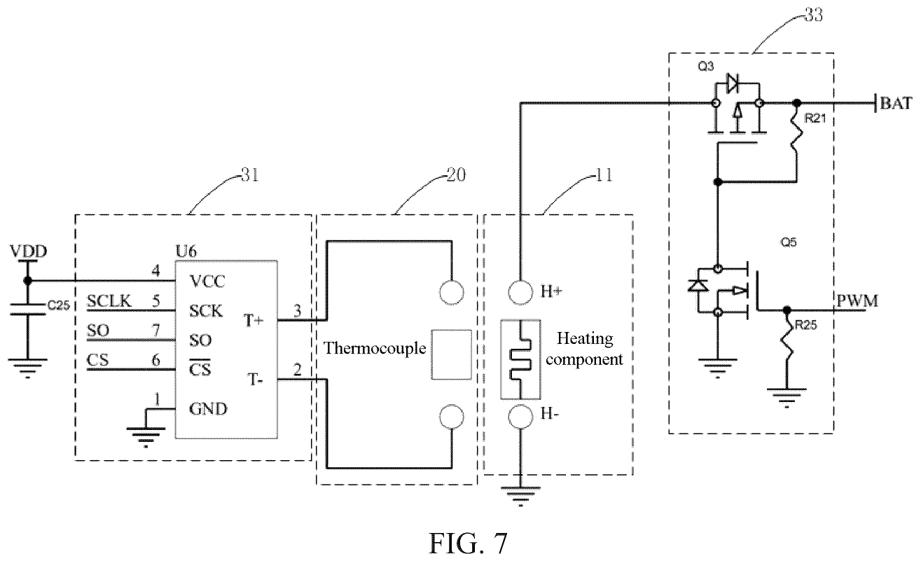

As shown in FIG. 7, in this embodiment, when the temperature measurement unit 20 is a thermocouple, the temperature measurement module 31 includes a thermocouple detection IC (U6). A fourth pin of the thermocouple detection IC is connected to a VDD and is grounded through a capacitor C25, and a second pin of the thermocouple detection IC is connected to a second terminal of the thermocouple. A third pin of the thermocouple detection IC is connected to a first terminal of the thermocouple, and a fifth pin of the thermocouple detection IC is connected to a 26^{th} pin of the controller 32. A seventh pin of the thermocouple detection IC is connected to a 27^{th} pin of the controller 32. In this embodiment, the controller 32 measures the temperature of the thermocouple in real time through the thermocouple detection IC, to measure the temperature of the heating element 112 in real time, and determines whether the user performs a puffing action according to a change in the temperature of the thermocouple within a preset time range.

As shown in FIG. 7, in this embodiment, a power module includes an MOS transistor Q5 and an MOS transistor Q3. A source of the MOS transistor Q5 is grounded, and a gate of the MOS transistor Q5 is connected to a twelfth pin of the controller 32. The gate of the MOS transistor Q5 is connected to a PWM signal. A drain of the MOS transistor Q5 is connected to a gate of the MOS transistor Q3, a source of the MOS transistor Q3 is connected to a battery (BAT), and a drain of the MOS transistor Q3 is connected to a positive electrode of the heating element 112. A negative electrode of the heating element 112 is grounded. In this embodiment, the MOS transistor Q5 drives the MOS transistor Q3 to be turned on/off according to the PWM signal outputted by the controller 32, to control electric energy provided by the battery to the heating element 112.

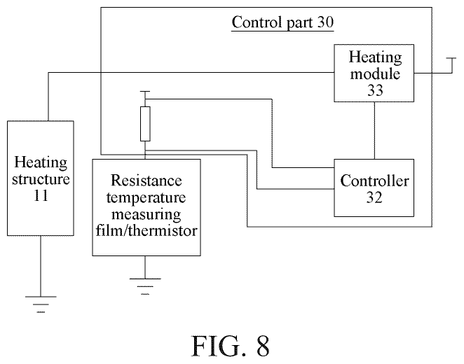

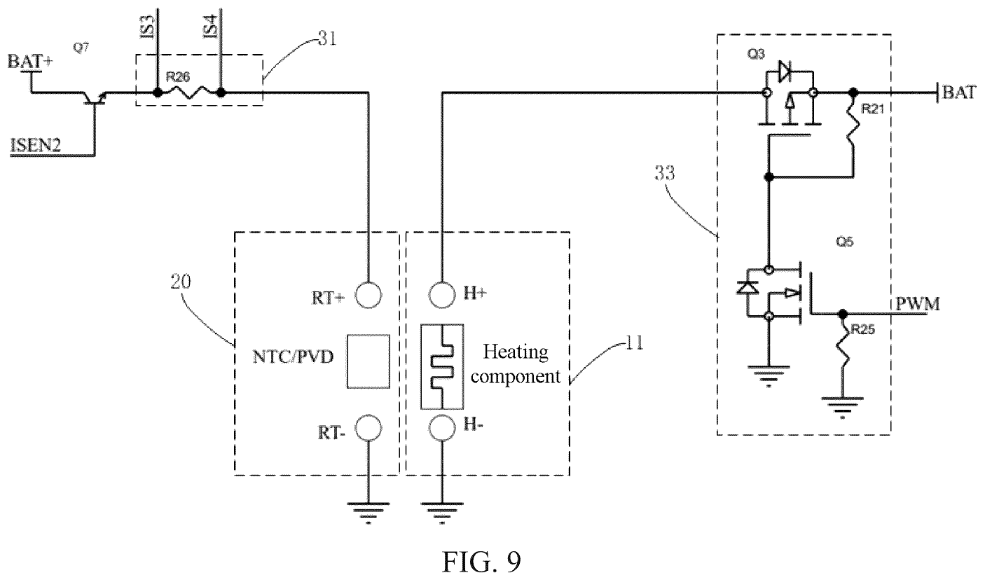

As shown in FIG. 8, in this embodiment, when a resistance temperature measuring film or a thermistor is adopted for the temperature measurement unit 20, the temperature measurement module 31 may be implemented by a temperature measurement circuit, where the temperature measurement circuit may be implemented by a resistor. Specifically, as shown in FIG. 9, a positive terminal of the resistance temperature measuring film is connected to a second terminal of a resistor R26, and the second terminal of the resistor R26 is further connected to a fourth pin of the controller 32. A first terminal of the resistor R26 is connected to a sixth pin of the controller 32, and the first terminal of the resistor R26 is also connected to an emitter of a triode Q7. A collector of the triode Q7 is connected to a positive terminal (BAT+) of a battery, and a base of the triode Q7 is connected to a third pin of the controller 32. The controller 32 controls the turn-on or turn-off of the triode Q7 by outputting a driving signal to the triode Q7, so as to control and adjust the electric energy provided to the resistance temperature measuring film/thermistor through the triode Q7.

In this embodiment, the controller 32 collects a voltage across the resistor R26, obtains a voltage across the resistance temperature measuring film/thermistor by subtracting the voltage across the resistor R26 from a power supply voltage (BAT), obtains a current flowing through the resistor R26 by dividing the voltage across the resistor R26 by a resistance value of the resistor R26 (the current flowing through the resistor R26 is equal to a current flowing through the resistance temperature measuring film/thermistor), and finally obtains a resistance value of the resistance temperature measuring film/thermistor, thereby measuring the temperature of the resistance temperature measuring film/thermistor.

FIG. 1 to FIG. 4 are schematic diagrams of arrangement of a single temperature measurement unit 20. It may be understood that, in some other embodiments, a plurality of temperature measurement units 20 may alternatively be provided. Specifically, the temperature measurement unit 20 includes a first temperature measuring element and a second temperature measuring element. The first temperature measuring element is arranged on the heating structure 11 or is spaced apart from the heating structure 11, and the first temperature measuring element is arranged close to the opening 1110 of the housing 111 and is configured to measure the temperature of the heating structure 11 to obtain a first real-time temperature. The second temperature measuring element is arranged on the heating structure 11 or is spaced apart from the heating structure 11, and the second temperature measuring element is arranged away from the opening 1110 and is configured to measure the temperature of the heating structure 11 to obtain a second real-time temperature.

The control unit 30 determines whether the user is in an exhaling state or an inhaling state according to the first real-time temperature and the second real-time temperature.

In some embodiments, in the inhaling state, air first flows through the opening 1110 and then flows along the housing 111. In this case, a change in the temperature of the first temperature measuring element is greater than that of the second temperature measuring element. In the exhaling state, air enters from a side away from the opening 1110, and then flows along the housing 111. In this case, a change in the temperature of the second temperature measuring element is greater than that of the first temperature measuring element. Therefore, a use state of the user can be determined by using a difference between the change in the temperature of the first temperature measuring element and the change in the temperature of the second temperature measuring element. Specifically, if the change in the temperature of the first temperature measuring element is greater than that of the second temperature measuring element, the user is in the inhaling state, or if the change in the temperature of the first temperature measuring element is less than that of the second temperature measuring element, the user is in the exhaling state.

Certainly, it may be understood that, in some other implementations, in the inhaling state, air enters from a side away from the opening 1110 and then flows along the housing 111. In this case, the change in the temperature of the first temperature measuring element is less than that of the second temperature measuring element. In the exhaling state, air first flows through the opening 1110 and then flows along the housing 111. In this case, the change in the temperature of the first temperature measuring element is greater than that of the second temperature measuring element. Therefore, if the change in the temperature of the first temperature measuring element is greater than that of the second temperature measuring element, the user is in the exhaling state, or if the change in the temperature of the first temperature measuring element is less than that of the second temperature measuring element, the user is in the inhaling state.

Further, in this embodiment, the control unit 30 controls an indicating module to output a mode misuse warning signal when determining that the user is in the exhaling state, or the control unit 30 reduces heating power when determining that the user is in the exhaling state. The heating power is reduced when it is detected that the current use state of the user is the exhaling state, so that the loss of the aerosol can be reduced.

The first temperature measuring element is arranged close to the opening 1110 and the second temperature measuring element is arranged away from the opening 1110, so that the use state of the user is detected. In addition, the loss of the aerosol caused in a misuse state of the user is avoided, thereby improving product use efficiency.

A puff detection method for the aerosol generating device 100 includes the following steps: measuring the temperature of the heating structure 11 by the temperature measurement unit 20 arranged on the heating structure 11 or spaced apart from the heating structure 11; and monitoring the temperature of the heating structure 11 by the control unit 30, and detecting a puffing action of the user according to a change in the temperature of the heating structure 11. Specifically, the temperature measurement unit 20 may be arranged close to the opening 1110 of the housing 111, and the temperature of the heating structure 11 may be measured by using a change in the temperature of the temperature measurement unit 20, so that whether a puffing action occurs can be determined according to the change in the temperature of the heating structure 11.

Alternatively, in some other embodiments, the puff detection method includes the following steps: measuring the temperature of the heating structure 11 by a first temperature measuring element to obtain a first real-time temperature; measuring the temperature of the heating structure 11 by a second temperature measuring element to obtain a second real-time temperature; and determining, by the control unit 30, whether the user is in the inhaling state or the exhaling state according to the first real-time temperature and the second real-time temperature.

The first temperature measuring element is arranged on the heating structure 11 or is spaced apart from the heating structure 11, and the first temperature measuring element is arranged close to the opening 1110 of the housing 111; the second temperature measuring element is arranged on the heating structure 11 or is spaced apart from the heating structure 11, and the second temperature measuring element is arranged away from the opening 1110.

Further, in this embodiment, the control unit 30 controls an indicating module to output a mode misuse warning signal when determining that the user is in the exhaling state, or the control unit 30 reduces heating power when determining that the user is in the exhaling state.

FIG. 11 to FIG. 14 show Embodiment 2 of the aerosol generating device 100 according to the present invention, which is different from Embodiment 1 in that the heating structure 11 is not limited to being partially inserted into the aerosol-forming substrate to heat the aerosol-forming substrate. In this embodiment, the heating structure 11 is a circumferential heating structure. The heating structure 11 may be sleeved on the periphery of a substrate segment of the aerosol-forming substrate, and heat the aerosol-forming substrate in a circumferential heating manner. In this embodiment, the housing 111 includes a first tube 111a and a second tube 111b. The first tube 111a is of a hollow structure with both ends open. The first tube 111a may be cylindrical, and the inner diameter of the first tube may be slightly greater than the outer diameter of the aerosol-forming substrate. A second accommodating cavity 1115 may be formed inside the first tube 111a to accommodate the aerosol-forming substrate and form a heating space for heating the substrate segment of the aerosol-forming substrate. An axial length of the first tube 111a may be greater than an axial length of the second tube 111b. The second tube 111b may be sleeved on the periphery of the first tube 111a, and the second tube 111b may be cylindrical. A radial dimension of the second tube 111b may be greater than that of the first tube 111a. That is, a gap is provided between the second tube 111b and the first tube 111a. The gap can form a first accommodating cavity 1113, and the first accommodating cavity 1113 is configured to accommodate the heating element 112. The heating element 112 is arranged on the periphery of the first tube 111a and is spaced apart from the outer wall of the first tube 111a. In some embodiments, the heating element 112 is wound around the periphery of the first tube 111a, and a gap 1114 is provided among the entire heating element, the inner wall of the second tube 111b, and the outer wall of the first tube 111a (that is, the heating element 112 is at least partially spaced apart from the housing 111), so that a certain temperature difference can be formed between the inner wall of the first accommodating cavity 1113 and the heating element 112, thereby achieving heat insulation. In some embodiments, the inner wall of the second tube 111b may be provided with a reflecting layer, which is configured to reflect heat from the heating element 112 and radiate the heat to the aerosol-forming substrate 200, so as to enhance heating energy efficiency.

In some other embodiments, the heating element 112 is not limited to being entirely spaced apart from the first tube 111a or the second tube 111b. In some other embodiments, the heating element 112 may alternatively be partially spaced apart from the first tube 111a, and a radial dimension of a partial segment of the heating part 1120 may be equivalent to an outer diameter of the first tube 111a, to achieve a limiting effect. In some embodiments, the heating element 112 may alternatively be partially spaced apart from the second tube 111b, and a radial dimension of a partial segment of the heating part 1120 may be equivalent to that of the second tube 111b.

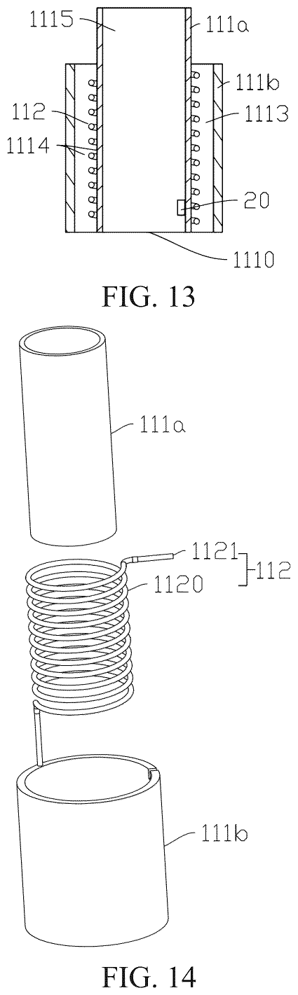

As shown in FIG. 13, in this embodiment, the temperature measurement unit 20 is arranged on the heating structure 11 or is spaced apart from the heating structure 11. The temperature measurement unit 20 may be spaced apart from the heating element 112 or may be closely attached to the heating element 112. Further, in this embodiment, as shown in FIG. 14, the temperature measurement unit 20 may be arranged close to the opening 1110 of the housing 111. The “close to” herein refers to that with a midpoint of the length of the housing 111 as a reference, a shorter distance from an end at the opening 1110 indicates being close, and a longer distance from the end at the opening 1110 indicates being far. Specifically, the temperature measurement unit 20 may be arranged on the inner wall or the outer wall of the housing 111. In this embodiment, the temperature measurement unit 20 is arranged on the inner wall of the housing 111. The temperature of the heating structure 11 can be measured by arranging the temperature measurement unit 20. The operating temperature of the light wave infrared heating element 112 is 500° C. to 1300° C., and the gap 1114 is provided between the heating element 112 and the housing 111. Because of the gap 1114, the surface temperature of the housing 111 can be controlled at 350° C. or below. Therefore, when the temperature measurement unit 20 is arranged on the inner wall or the outer wall of the housing 111, the sensitivity of temperature measurement is higher.

The embodiments in this specification are all described in a progressive manner. Description of each of the embodiments focuses on differences from other embodiments, and reference may be made to each other for the same or similar parts among the embodiments. The apparatus embodiments basically correspond to the method embodiments and therefore are only briefly described, and reference may be made to the method embodiments for the associated part.

A person skilled in the art may further appreciate that, units and algorithm steps of each example described in combination with the disclosed embodiments herein can be implemented by electronic hardware, computer software, or a combination thereof. To clearly describe interchangeability between the hardware and the software, compositions and steps of each example have been generally described according to functions in the foregoing descriptions. Whether the functions are executed in a manner of hardware or software depends on specific applications and design constraint conditions of the technical solutions. A person skilled in the art may use different methods to implement the described functions for each specific application, but such implementation is not to be considered beyond the scope of the present invention.

Steps of the method or algorithm described in combination with the embodiments disclosed herein may be directly implemented by using hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or any storage medium of other forms well-known in the technical field.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An aerosol generating device, comprising:
a heating structure;
a temperature measurement unit; and
a control unit,
wherein the heating structure comprises a heating element and a housing,
wherein the heating element is at least partially spaced apart from the housing, the heating element is configured to be powered for heating and generating infrared light, the infrared light passing through the housing so as to heat an aerosol-forming substrate,
wherein the temperature measurement unit is arranged on the heating structure or is spaced apart from the heating structure, and is configured to measure a temperature of the heating structure, and
wherein the control unit is configured to monitor the temperature of the heating structure and detect a puffing action of a user according to a change in the temperature of the heating structure.

2. The aerosol generating device of claim 1, wherein the temperature measurement unit is arranged on an inner wall or an outer wall of the housing.

3. The aerosol generating device of claim 2, wherein the temperature measurement unit is spaced apart from the heating element or is attached to the heating element.

4. The aerosol generating device of claim 1, wherein the temperature measurement unit is spaced apart from the heating element or is attached to the heating element,
wherein the housing has an opening, and
wherein the temperature measurement unit is arranged close to the opening.

5. The aerosol generating device of claim 1, wherein the heating element is located inside the housing, and
wherein the housing is at least partially configured to be inserted into the aerosol-forming substrate.

6. The aerosol generating device of claim 1, wherein the heating element is arranged on a periphery of the housing in a spaced-apart manner, and
wherein the housing is hollow and forms a second accommodating cavity configured to accommodate the aerosol-forming substrate.

7. The aerosol generating device of claim 1, wherein the housing comprises a first tube and a second tube sleeved on a periphery of the first tube,
wherein a gap is provided between the first tube and the second tube, and the gap forms a first accommodating cavity configured to accommodate the heating element,
wherein the heating element is arranged on a periphery of the first tube and is spaced apart from an outer wall of the first tube, and
wherein a second accommodating cavity configured to heat the aerosol-forming substrate is formed inside the first tube.

8. The aerosol generating device of claim 1, wherein the control unit comprises a temperature measurement module, and
wherein the temperature measurement module is connected to the temperature measurement unit, and is configured to monitor a temperature of the temperature measurement unit in real time to obtain the temperature of the heating structure.

9. The aerosol generating device of claim 8, wherein the temperature measurement unit comprises a first temperature sensor or a second temperature sensor,
wherein the first temperature sensor comprises a thermocouple, and
wherein the second temperature sensor comprises a resistance temperature measuring film or a thermistor.

10. The aerosol generating device of claim 1, wherein the control unit comprises a heating module and a controller;
wherein the heating module is connected to the heating element,
wherein the heating module is configured to adjust, according to control by the controller, electric energy provided to the heating element, and
wherein the controller is configured to control output power of the heating module to control the temperature of the heating element, monitor the temperature of the heating structure, and detects a puffing action of the user according to a change in the temperature of the heating structure.

11. The aerosol generating device of claim 1, wherein the control unit is configured to detect a puffing action of a user according to a change in the temperature of the heating structure within a preset time range.

12. The aerosol generating device of claim 11, wherein the control unit is configured to detect the puffing action of the user according to whether the change in the temperature of the heating structure exceeds a threshold within the preset time range.

13. The aerosol generating device of claim 11, wherein the control unit is configured to detect the puffing action of the user according to whether a drop value of the temperature of the heating structure is greater than a drop threshold within the preset time range, or
wherein the control unit is configured to detect the puffing action of the user according to whether a drop slope of the temperature of the heating structure is greater than a preset slope within the preset time range.

14. The aerosol generating device of claim 1, wherein the temperature measurement unit comprises a first temperature measuring element and a second temperature measuring element,
wherein the first temperature measuring element is arranged on the heating structure or is spaced apart from the heating structure, and the first temperature measuring element is arranged close to an opening of the housing and is configured to measure the temperature of the heating structure to obtain a first real-time temperature,
wherein the second temperature measuring element is arranged on the heating structure or is spaced apart from the heating structure, and the second temperature measuring element is arranged away from the opening and is configured to measure the temperature of the heating structure to obtain a second real-time temperature, and
wherein the control unit is configured to determine whether the user is in an exhaling state or an inhaling state according to the first real-time temperature and the second real-time temperature.

15. The aerosol generating device of claim 14, wherein the control unit is configured to control an indicating module so as to output a mode misuse warning signal upon determination that the user is in the exhaling state, or the control unit is configured to reduce heating power upon determination that the user is in the exhaling state.

16. A puff detection method for an aerosol generating device that includes a heating structure, a temperature measurement unit, and a control unit, the heating structure including a heating element and a housing, the heating element being at least partially spaced apart from a tube wall of the housing, the heating element being electrified for heating and generating infrared light, the infrared light passing through the housing so as to heat an aerosol-forming substrate, the method comprising:
measuring a temperature of the heating structure by the temperature measurement unit arranged on the heating structure or spaced apart from the heating structure; and
monitoring the temperature of the heating structure by the control unit and detecting a puffing action of a user according to a change in the temperature of the heating structure.

17. The puff detection method of claim 16, wherein the temperature measurement unit comprises a first temperature measuring element and a second temperature measuring element;
wherein the first temperature measuring element is arranged on the heating structure or is spaced apart from the heating structure, and the first temperature measuring element is arranged close to an opening of the housing,
wherein the second temperature measuring element is arranged on the heating structure or is spaced apart from the heating structure, and the second temperature measuring element is arranged away from the opening, and
wherein the puff detection method further comprises:
measuring the temperature of the heating structure by the first temperature measuring element to obtain a first real-time temperature,
measuring the temperature of the heating structure by the second temperature measuring element to obtain a second real-time temperature, and
determining, by the control unit, whether the user is in an exhaling state or an inhaling state according to the first real-time temperature and the second real-time temperature.

18. The puff detection method of claim 17, further comprising:
controlling, by the control unit, an indicating module so as to output a mode misuse warning signal when determining that the user is in the exhaling state, or
reducing, by the control unit, heating power when determining that the user is in the exhaling state.
